(19) United States
(12) Patent Application Publication
(10) Pub. No.: US 2022/0248209 A1
(43) Pub. Date: Aug. 4, 2022

(54) METHOD AND APPARATUS FOR UPDATING MULTI-USIM UE RADIO CAPABILITY OVER SAME OR DIFFERENT OPERATORS

(71) Applicant: SHARP KABUSHIKI KAISHA, Sakai City, Osaka (JP)

(72) Inventor: Kamel M. SHAHEEN, Vancouver, WA (US)

(21) Appl. No.: 17/623,830

(22) PCT Filed: Jul. 20, 2020
(86) PCT No.: PCT/JP2020/028000

§ 371 Date: Dec. 29, 2021

Related U.S. Application Data
(60) Provisional application No. 62/879,313, filed on Jul. 26, 2019.

(51) Int. Cl. H04W 8/18; H04W 60/04

(52) U.S. Cl. CPC H04W 8/183; H04W 84/042; H04W 60/04

(57) ABSTRACT

A user equipment (UE) for wireless communication is disclosed. The UE includes one or more non-transitory computer-readable media having computer-executable instructions embodied here-on, and at least one processor coupled to the one or more non-transitory computer-readable media, and configured to execute the computer-executable instructions to receive a multiple-universal subscriber identity module (multi-USIM) Radio capability update request, from at least one Public Land Mobile Network (PLMN), to update radio capabilities of multi-USIM based operations, in response to detecting the activation of a second USIM in addition to a first USIM in the UE, and send a multi-USIM UE Radio capability update response to the at least one PLMN.

### CROSS REFERENCE

This Nonprovisional application claims priority under 35 U.S.C. § 119 on provisional Application No. 62/879,313 on Jul. 26, 2019, the entire contents of which are hereby incorporated by reference.

### TECHNICAL FIELD

The present disclosure generally relates to wireless communication, and more par-ticularly, to multiple-universal subscriber identity module (multi-USIM) based operations in a user equipment (UE) supporting the same or different operators.

### BACKGROUND ART

In wireless communication systems, support for multi-USIM based operations in a UE is handled in an implementation-specific manner without any support from 3rd Generation Partnership Project (3GPP) specifications, resulting in a variety of implementations and UE behaviors. In a multi-USIM device, the USIMs typically share common radio and baseband components. Thus, the multi-USIM device may register in different networks but using one radio front-end (RF) and base band.

In the next generation (e.g., fifth generation (5G) new radio (NR) wireless communication networks, a multi-USIM UE is expected to be in Radio Resource Control (RRC) Connected state with only one network at a time, while being able to receive paging, perform signal measurements, or read system information, and determine if it needs to respond to paging requests from other networks. With a single RF plate-form, however, the UE must listen to paging of the other connection(s), and the network needs to be aware of the multi-registration scenario. When a UE is paged on a second system while connected to a first system, the paged UE may drop the connection on the first system and attempt to access the second system without releasing the first connection due to lack of time to switch systems. Such behaviors can cause per-formance degradations and reductions in overall system capacity.

On the network end, the current network systems remain ignorant of the UEs' capability to support multi-USIM based operations. In order to support multi-USIM UEs, the network systems need to be aware of such capabilities in order to coordinate the operations of multi-USIM registrations, potential simultaneous operations and collision avoidance.

Thus, there is a need in the art for multi-USIM based operation UE and multi-network coordination.

### SUMMARY OF INVENTION

In one example, a user equipment (UE) for wireless communication, the UE comprising: one or more non-transitory computer-readable media having computer-executable instructions embodied thereon; at least one processor coupled to the one or more non-transitory computer-readable media, and configured to execute the computer-executable instructions to: receive a multiple-universal subscriber identity module (multi-USIM) Radio capability update request, from at least one Public Land Mobile Network (PLMN), to update radio capabilities of multi-USIM based operations, in response to detecting the activation of a second USIM in addition to a first USIM in the UE; and send a multi-USIM UE Radio capability update response to the at least one PLMN.

In one example, a user equipment (UE) for wireless communication, the UE comprising: one or more non-transitory computer-readable media having computer-executable instructions embodied thereon; at least one processor coupled to the one or more non-transitory computer-readable media, and configured to execute the computer-executable instructions to: receive a broadcast message, from a base station associated with at least one Public Land Mobile Network (PLMN), the broadcast message including an indication of whether the base station supports multiple-universal subscriber identity module (multi-USIM) based operations, and capabilities of the base station associated with the multi-USIM based operations.

In one example, a method of a user equipment (UE), the method comprising: receiving a multiple-universal subscriber identity module (multi-USIM) Radio capability update request, from at least one Public Land Mobile Network (PLMN), to update radio capabilities of multi-USIM based operations, in response to detecting the activation of a second USIM in addition to a first USIM in the UE; and sending a multi-USIM UE Radio capability update response to the at least one PLMN.

In one example, a base station comprising: one or more non-transitory computer-readable media having computer-executable instructions embodied thereon; at least one processor coupled to the one or more non-transitory computer-readable media, and configured to execute the computer-executable instructions to: send a multiple-universal subscriber identity module (multi-USIM) Radio capability update request, to a user equipment (UE) detecting a second USIM in addition to a first USIM in the UE, to update radio capabilities of multi-USIM based operations; receive a multi-USIM UE Radio capability update response from the UE.

In one example, a base station comprising: one or more non-transitory computer-readable media having computer-executable instructions embodied thereon; at least one processor coupled to the one or more non-transitory computer-readable media, and configured to execute the computer-executable instructions to: send a broadcast message to a user equipment (UE), the broadcast message including an indication of whether the base station associated with at least one Public Land Mobile Network (PLMN) supports multiple-universal subscriber identity module (multi-USIM) based operations and capabilities of the base station associated with the multi-USIM based operations.

In one example, a method of a base station, the method comprising: sending a multiple-universal subscriber identity module (multi-USIM) Radio capability update request, to a user equipment (UE) detecting a second USIM in addition to a first USIM in the UE, to update radio capabilities of multi-USIM based operations; receiving a multi-USIM UE Radio capability update response from the UE.

### BRIEF DESCRIPTION OF DRAWINGS

Implementations of the present technology will now be described, by way of example only, with reference to the attached figures.

FIG. 1 is a block diagram of a multi-USIM UE supporting the same or different operators, in accordance with various example implementations of the present disclosure.

FIG. 2 is a flowchart diagram illustrating a method of a UE for performing multi-USIM registrations in different communication networks, in accordance with example implementations of the present disclosure.

FIG. 3 is a signaling sequence diagram for schematically illustrating a method of reporting a multi-USIM presence in a UE and capabilities of the multiple USIMs to a wireless communication network through an access registration procedure, in accordance with example implementations of the present disclosure.

FIG. 4 is a signaling sequence diagram for schematically illustrating a method of reporting a multi-USIM presence in a UE and updating the UE's radio capabilities of multi-USIM based operations to a wireless communication network, in accordance with example implementations of the present disclosure.

FIG. 5A is a flowchart diagram illustrating a method of a multi-USIM based operation UE for updating the UE's radio capabilities of multi-USIM based operations, in accordance with example implementations of the present disclosure.

FIG. 5B is a flowchart diagram illustrating a method of a network for updating a UE's radio capabilities of multi-USIM based operations, in accordance with example implementations of the present disclosure.

FIG. 6A is a diagram illustrating information message through which a multi-USIM Radio capability update request may be transferred, in accordance with example implementations of the present disclosure.

FIG. 6B is a diagram illustrating information element through which a multi-USIM Radio capability update request may be transferred, in accordance with example implementations of the present disclosure.

FIG. 6C is a diagram illustrating information element through which a multi-USIM Radio capability update request may be transferred, in accordance with example implementations of the present disclosure.

FIG. 7A is a diagram illustrating information message through which a multi-USIM UE radio capability update response may be transferred, in accordance with example implementations of the present disclosure.

FIG. 7B is a diagram illustrating information message through which a multi-USIM UE radio capability update response may be transferred, in accordance with example implementations of the present disclosure.

FIG. 7C is a diagram illustrating information element through which a multi-USIM UE radio capability update response may be transferred, in accordance with example implementations of the present disclosure.

FIG. 7D is a diagram illustrating information message through which a multi-USIM UE radio capability update response may be transferred, in accordance with example implementations of the present disclosure.

FIG. 7E is a diagram illustrating information element through which a multi-USIM UE radio capability update response may be transferred, in accordance with example implementations of the present disclosure.

FIG. 7F is a diagram illustrating information element through which a multi-USIM UE radio capability update response may be transferred, in accordance with example implementations of the present disclosure.

FIG. 8 is a signaling sequence diagram for schematically illustrating a method of broadcasting a broadcast message indicating multi-USIM support by a base station and updating a UE's radio capabilities of multi-USIM based operations, in accordance with example implementations of the present disclosure.

FIG. 9A is a flowchart diagram illustrating a method of a UE for receiving a broadcast message indicating multi-USIM support from a base station, and sending the UE's radio capabilities or radio capability update for multi-USIM based operations to the base station, in accordance with example implementations of the present disclosure.

FIG. 9B is a flowchart diagram illustrating a method of a base station for broadcasting a broadcast message indicating multi-USIM support by the base station and receiving radio capability information or radio capability update information from a UE for multi-USIM based operations, in accordance with example implementations of the present disclosure.

### DESCRIPTION OF EMBODIMENTS

The 3GPP is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access network system (E-UTRAN).

At least some aspects of the systems and methods disclosed herein may be described in relation to the 3GPP LTE, LTE-Advanced (LTE-A) and other standards (e.g., 3GPP Releases 8, 9, 10, 11, 12, 13, 14 and/or 15) including New Radio (NR) which is also known as 5G. However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In de-scribing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In the 3GPP specifications, a base station is typically referred to as a Node B, an evolved Node B (eNB), a home enhanced or evolved Node B (HeNB), a next Generation Node B (gNB) or some other similar terminology. As the scope of the disclosure should not be limited to 3GPP standards, the terms “base station,” “Node B,” “eNB,” “HeNB,” and “gNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB and gNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The 5th generation communication systems, dubbed NR (New Radio technologies) by 3GPP, envision the use of time/frequency/space resources to allow for services, such as eMBB (enhanced Mobile Broad-Band) transmission, URLLC (Ultra-Reliable and Low Latency Communication) transmission, and mMTC (massive Machine Type Communication) transmission. Also, in NR, single-beam and/or multi-beam operations is considered for downlink and/or uplink transmissions.

In order for the services to use the time/frequency/space resource efficiently, it would be useful to be able to efficiently control uplink transmissions. Therefore, a procedure for efficient control of uplink transmissions should be designed. However, the detailed design of a procedure for uplink transmissions has not been studied yet.

According to the systems and methods described herein, a UE may transmit multiple reference signals (RSs) associated with one or more Transmission Reception Points (TRPs) on a UL antenna port. For example, multiple UL RSs respectively associated with one or more TRPs may be transmitted on a UL antenna port. Namely, there may be one or more UL RSs transmitted per UL antenna port. Also, there may be one or more UL RSs transmitted per TRP.

In an example, one TRP may be associated with one UL antenna port. In another example, one TRP may be associated with multiple UL antenna port(s). In another example, multiple TRP(s) may be associated with multiple UL antenna port(s). In yet another example multiple antenna port(s) may be associated with one UL antenna port. The TRP(s) described herein are assumed to be included in the antenna port(s) for the sake of simple description.

Here, for example, multiple UL RSs transmitted on an UL antenna port may be defined by the same sequence (e.g., a demodulation reference signal sequence, and/or a reference signal sequence). For example, the same sequence may be generated based on a first parameter configured by a higher layer. The first parameter may be associated with a cyclic shift, and/or information associated with a beam index.

Or, multiple UL RSs transmitted on an UL antenna port may be identified by a different sequence. Each of the different signal sequence may be generated based on each of more than one second parameter(s) configured by a higher layer. One second parameter among more than one second parameters may be indicated by DCI. Each of the second parameters may be associated with a cyclic shift, and/or information associated with a beam index.

Also, resource element(s) to which multiple UL RSs transmitted on a UL antenna port are mapped may be defined by the same value of a frequency shift. For example, the same value of the frequency shift may be given by a third parameter configured by a higher layer. The third information may be associated with a beam index.

Alternatively, resource element(s) to which multiple UL RSs transmitted on a UL antenna port are mapped may be identified by different values of a frequency shift. Each of the different values of the frequency shift may be given by each of more than one fourth parameter(s) configured by a higher layer. One fourth parameter among more than one parameters may be indicated by DCI. Each of the fourth parameters may be associated with a beam index.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

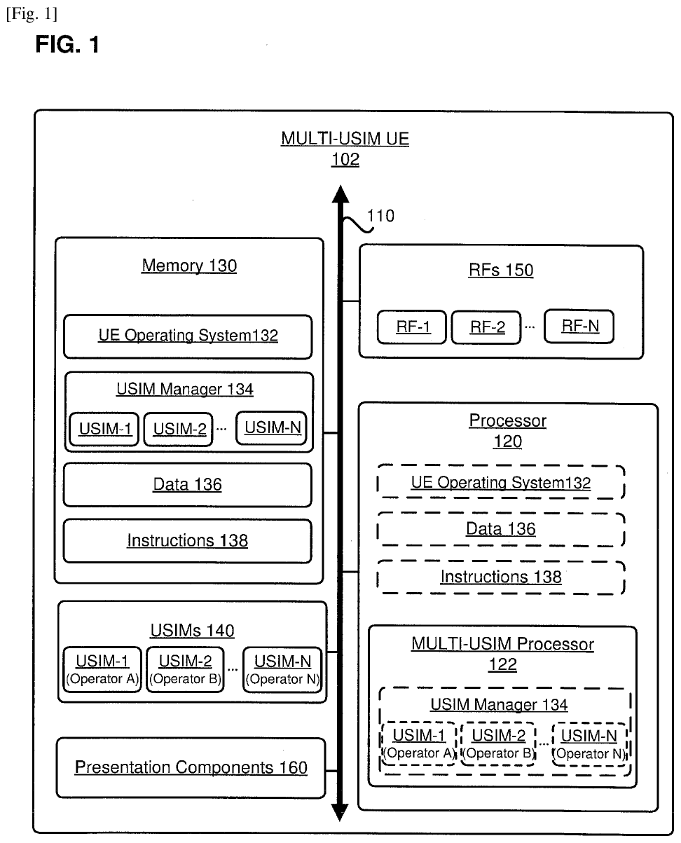

FIG. 1 is a block diagram of a multi-USIM UE supporting the same or different operators, in accordance with various example implementations of the present disclosure. As shown in FIG. 1, multi-USIM UE 102 may include processor 120, memory 130, multiple USIMs 140 belonging to different networks/operators, multiple Radio Front-end circuitries (RFs) 150, and one or more presentation components 160. Multi-USIM UE 102 may also include one or more radio frequency spectrum band modules, one or more base station communications modules, one or more network communications modules, and one or more system communications management modules, Input/Output (I/O) ports, I/O components, and power supply (not explicitly shown in FIG. 1). Each of these components may be in communication with each other, directly or indirectly, over one or more buses 110.

In various implementations of the present disclosure, processor 120 (e.g., having processing circuitry) may include an intelligent hardware device, e.g., a Central Processing Unit (CPU), a microcontroller, an ASIC, and etc. Processor 120 may also include memory storage. As illustrated in FIG. 1, processor 120 may be responsible for running UE operating system 132, and processing data 136 and instructions 138 received from memory 130, information through RFs 150, the base band communications module, and/or the network communications module. Processor 120 may also process information to be sent to RFs 150 for transmission to the network communications module for transmission to a core network. In the present implementation, processor 120 may include multi-USIM processor 122 for processing instructions from USIM manager 134 for one or more of USIMs of multi-USIM UE 102, for example.

As illustrated in FIG. 1, memory 130 may store UE operating system 132, USIM manager 134, data 136, and computer-readable, computer-executable instructions 138 (e.g., software codes) that are configured to, when executed, cause processor 120 to perform various functions described herein. Alternatively, USIM manager 134 and/or instructions 138 may not be directly executable by processor 120 but be configured to cause multi-USIM UE 102 (e.g., when compiled and executed) to perform various functions described herein.

In various implementation of the present disclosure, memory 130 may include a variety of computer-readable media. Computer-readable media may be any available media that may be accessed by multi-USIM UE 102 and include both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable.

Computer storage media includes RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media does not comprise a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. In various implementation of the present disclosure, memory 130 may include computer-storage media in the form of volatile and/or non-volatile memory. Memory 130 may be removable, non-removable, or a combination thereof. Example memory includes solid-state memory, hard drives, optical-disc drives, and etc.

As illustrated in FIG. 1, multi-USIM UE 102 may include multiple USIMs 140, such as USIM-1, USIM-2, through USIM-N. USIM-1, USIM-2, through USIM-N may belong to the same or different network/operator (e.g., Public Land Mobile Network (PLMN)). For example, USIM-1, USIM-2, through USIM-N may belong to Operator A, Operator B, through Operator N, respectively. It should be noted that, although USIMs are described in the present implementation and various implementations of the present disclosure, other subscriber identity modules or subscriber identification modules (e.g., SIMs) can also be used.

As shown in FIG. 1, multi-USIM UE 102 may include multiple RFs 150, such as RF-1, RF-2, through RF-N. Each of the RFs 150 may include a transmitter (e.g., transmitting/transmission circuitry) and a receiver (e.g., receiving/reception circuitry). In some implementations of present disclosure, RF-1, RF-2, through RF-N of RFs 150 may respectively correspond to USIM-1, USIM-2, through USIM-N, where USIM-1, USIM-2, through USIM-N may transmit and/or receive data and control channels, for example, through RF-1, RF-2, through RF-N, respectively.

As shown in FIG. 1, multi-USIM UE 102 may include presentation components 160 for presenting data indications to a person or other device. Examples of presentation components 160 may include a display device, speaker, printing component, vibrating component, etc.

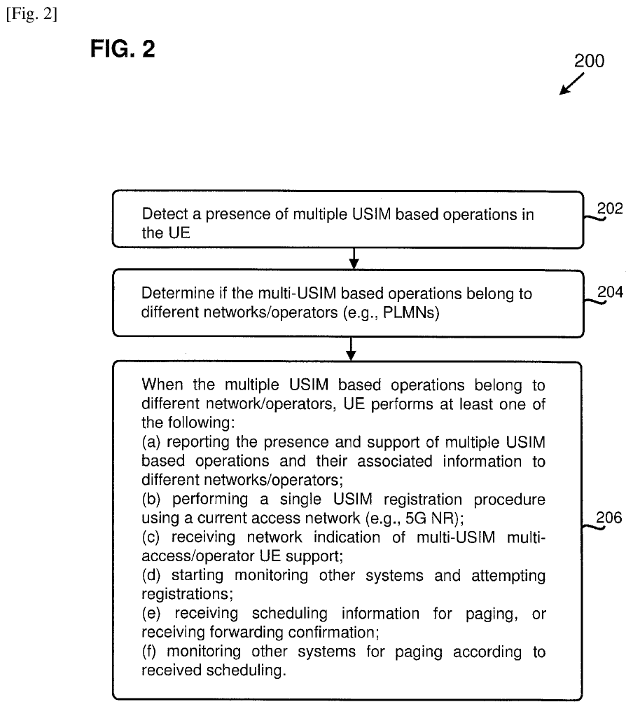

FIG. 2 is a flowchart diagram illustrating a method of a UE for performing multi-USIM registrations in different communication networks, in accordance with example implementations of the present disclosure. As illustrated in FIG. 2, flowchart 200 may include actions 202, 204, and 206. In one implementation, the UE described in flowchart 200 may correspond to multi-USIM UE 102 in FIG. 1.

In action 202, the UE may detect a presence of multiple USIM based operations in the UE. In one implementation, before the UE is powered on, two or more USIMs are inserted into the USIM card slots of the UE, for example. When the UE is powered on, the UE (e.g., through multi-USIM processor 122 and USIM manager 134 in FIG. 1) may detect the presence of the multiple USIM based operations. In another implementation, the UE is initially powered on with a first USIM based operation, and a second USIM based operation is later inserted into the UE. The UE (e.g., through multi-USIM processor 122 and USIM manager 134 in FIG. 1) may detect the second USIM based operation while the UE is operating with the first USIM based operation already registered with the current network.

In action 204, the UE may determine if the multi-USIM based operations belong to different networks/operators. In one implementation, the UE may check the operator IDs (e.g., PLMN IDs) associated with the USIM based operations in the UE to determine if the multi-USIM based operations belong to different networks/operators. For example, when the PLUM IDs of the USIM based operations are different, then the multiple USIM based operations belong to different networks/operators.

In action 206, when the multi-USIM based operations belong to different networks/operators, the UE may report the presence and support of multi-USIM based operations and their associated information to the networks/operators. The UE may perform a single USIM registration procedure using a current (or preferred) access network (e.g., 5G NR). The UE may receive a network indication of multi-USIM and multi-access/operator (e.g., PLMN) UE support. The UE may start monitor other systems and attempt registrations. The UE may receive scheduling information for paging or receiving forwarding confirmation. The UE may also monitor other systems for paging according to received scheduling.

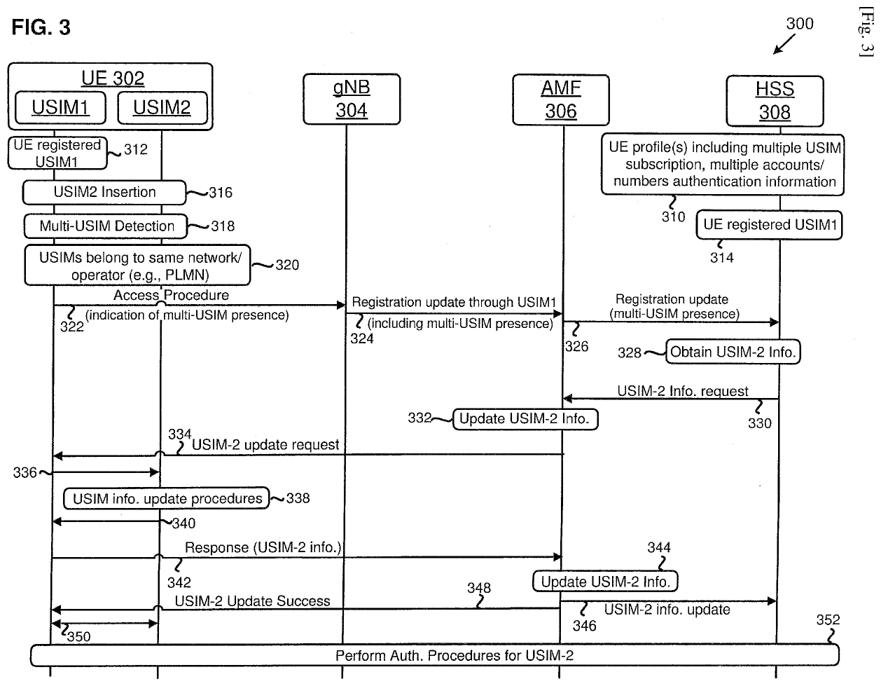

FIG. 3 is a signaling sequence diagram for schematically illustrating a method of reporting a multi-USIM presence in a UE and capabilities of the multiple USIMs to a wireless communication network through an access registration procedure, in accordance with example implementations of the present disclosure.

As shown in FIG. 3, in diagram 300, UE 302 may report or register the presence and capabilities of multi-USIM based operations associated with each USIM to Home Subscriber Server (HSS) 308 through next generation NodeB (gNB) 304 and Access and Mobility Management Function (AMF) 306, for example, through one or more of actions 310, 312, 314, 316, 318, 320, 322, 324, 326, 328, 330, 332, 334, 336, 338, 340, 342, 344, 346, 348, 350, 352, and 354. In one implementation, UE 302 described in diagram 300 may correspond to multi-USIM UE 102 in FIG. 1. It should be noted that, in diagram 300, although UE 302 is shown to include two USIM based operations (USIM1 and USIM2 based operations), UE 302 may include and support more than two USIM based operations.

In action 310, HSS 308 may store UE profiles including multi-USIM subscriptions, multiple accounts/numbers authentication information for one or more UEs.

In action 312, USIM1 of UE 302's registration and authentication are successful. For example, the Attach is complete for USIM1.

In action 314, in HSS 308, USIM1 of UE 302 is registered and authenticated.

In action 316, USIM2 may be inserted into UE 302.

In action 318, UE 302 may detect a presence of multiple USIMs. For example, UE 302 (e.g., through multi-USIM processor 122 and USIM manager 134 in FIG. 1) may detect USIM2 while UE 302 is operating with USIM1 that is already registered with the network (e.g., AMF 306 and HSS 308). Thus, when USIM2 is inserted, UE 302 may detect the presence of both USIM1 and USIM2.

In action 320, UE 302 may determine if USIM1 and USIM2 belong to the same network/operator. In one implementation, UE 302 may check the operator IDs (e.g., PLMN IDs) associated with USIM1 and USIM2 to determine if the operator IDs are the same. For example, each operator ID may include a mobile country code (MCC) and a mobile network code (MNC). When the MCC and MNC of USIM1 match those of USIM2, then UE 302 determines that USIM1 and USIM2 belong to the same network/operator. UE 302 may also determine if USIM 1 and USIM2 belong to different networks/operators. For example, when the MCC and MNC of USIM1 are different from those of USIM2, then UE 302 determines that USIM1 and USIM2 belong to different networks/operators.

In action 322, UE 302 may initiate an access procedure with gNB 304 using USIM1. In the access procedure, UE 302 may send a message to gNB 304 using USIM1, the associated RF circuitry (e.g., RF1 in FIG. 1), and the current access network system of USIM1. The message may include an indication indicating the presence of USIM1 and USIM2 in UE 302, and USIM2 related information (e.g., phone number, IMSI, IMEI, TMSI, etc.). The message may also include updated capabilities of USIM1.

In action 324, gNB 304 may send the message having the multi-USIM presence of USIM1 and USIM2 to AMF 306 through a registration update procedure.

In action 326, AMF 306 may send the message having the multi-USIM presence of USIM1 and USIM2 to HSS 308 through the registration update procedure.

In action 328, HSS 308 may obtain information of USIM 2.

In action 330, HSS 308 may send a message to AMF 306 to request for USIM-2's information, such as associated capabilities (e.g., NAS and/or AS capabilities) of USIM2 for multi-USIM based operations.

In action 332, AMF 306 may imitate a USIM-2 information update.

In action 334, AMF 306 may send a USIM-2 update request to USIM1 of UE 302.

In action 336, a USIM manager (e.g., USIM manager 134 in FIG. 1) of UE 302 may convey the USIM 2 update request from USIM 1 to USIM 2, for example, through tunneling.

In action 338, USIM 2 may perform USIM 2 information update procedures, to respond to the update request.

In action 340, the USIM manager (e.g., USIM manager 134 in FIG. 1) of UE 302 may convey the associated capabilities (e.g., NAS and/or AS capabilities) of USIM 2 from USIM 2 to USIM 1, for example, through tunneling.

In action 342, UE 302, through USIM 1, may provide a USIM-2 update response having USIM 2's information to AMF 306.

In action 344, AMF 306 may update USIM 2's information.

In action 346, AMF 306 may provide the updated USIM 2's information to HSS 308.

In action 348, AMF 306 may send a USIM 2 update success message to UE 302 through USIM 1. Also, AMF 306 may send an authentication request for USIM2 to USIM1 of UE 302. The authentication request may be received by UE 302 through USIM1 and the RF circuitry associated with USIM1 (e.g., RF1 in FIG. 1). The authentication request may include the RAND and the AUTN which it received from HSS 308.

In action 350, a USIM manager (e.g., USIM manager 134 in FIG. 1) of UE 302 may convey the authentication request from USIM1 to USIM2, for example, through tunneling.

In action 352, the authentication procedures for USIM 2 may be performed. For example, a USIM processor (e.g., multi-USIM processor 122 in FIG. 1) of UE 302 may process the authentication request, using the RAND it received and its pre-shared secret key to generate authentication parameters through authentication calculation. USIM2 may send an authentication response of USIM2, including a Response (RES), back to USIM1. USIM1 may send the authentication response of USIM2 back to AMF 306 through USIM1 and the RF associated with USIM1. If the RES of USIM2 from UE 302 matches the XRES AMF 306 received from HSS 308, then USIM2 is authenticated successfully. AMF 306 may send a USIM2 authentication success message to HSS 308. AMF 306 may send a registration and authentication success message to USIM1 through the associated RF circuitry (e.g., RF1 in FIG. 1) of USIM1. The USIM manager (e.g., USIM manager 134 in FIG. 1) of UE 302 may convey the registration and authentication success message from USIM1 to USIM2, for example, through tunneling. USIM2 of UE 302's registration and authentication are successful. For example, the Attach is complete for USIM2. For example, AMF 306 may start managing USIM2 of UE 302.

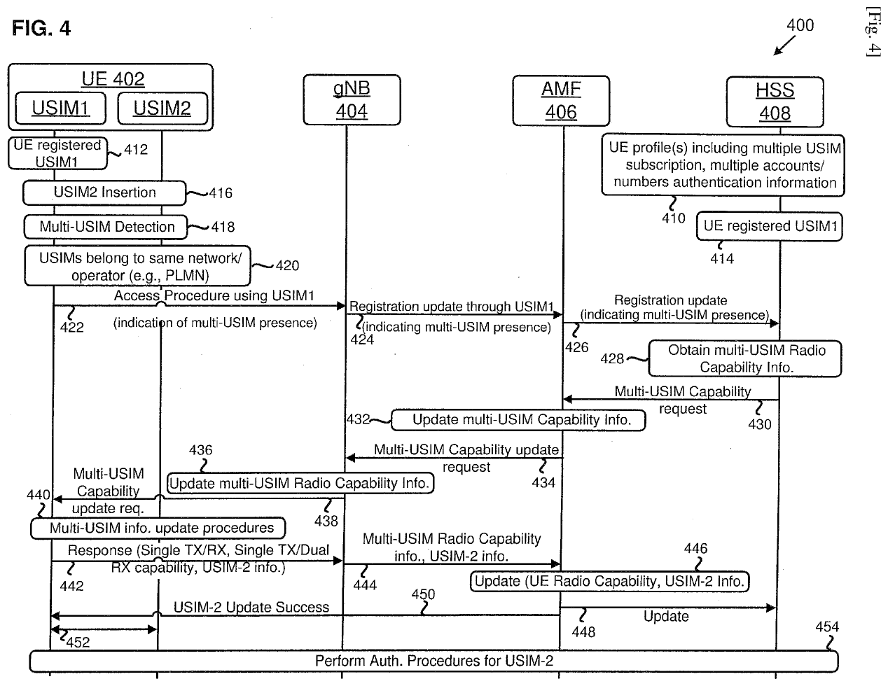

FIG. 4 is a signaling sequence diagram for schematically illustrating a method of reporting a multi-USIM presence in a UE and updating the UE's radio capabilities of multi-USIM based operations to a wireless communication network, in accordance with example implementations of the present disclosure.

As shown in FIG. 4, in diagram 400, UE 402 may report or register the presence and capabilities of multi-USIM based operations associated with each USIM to Home Subscriber Server (HSS) 408 through next generation NodeB (gNB) 404 and Access and Mobility Management Function (AMF) 406, for example, through one or more of actions 410, 412, 414, 416, 418, 420, 422, 424, 426, 428, 430, 432, 434, 436, 438, 440, 442, 444, 446, 448, 450, 452, 454, and 456. In one implementation, UE 402 described in diagram 400 may correspond to multi-USIM UE 102 in FIG. 1. It should be noted that, in diagram 400, although UE 402 is shown to include two USIM based operations (USIM1 and USIM2 based operations), UE 402 may include and support more than two USIM based operations.

In the present implementation, actions 410, 412, 414, 416, 418, 420, 422, 424, and 426 may be substantially similar to actions 310, 312, 314, 316, 318, 320, 322, 324, and 326 in FIG. 3. Thus, the descriptions of actions 410, 412, 414, 416, 418, 420, 422, 424, and 426 are omitted for brevity.

In action 428, after HSS 408 receives the message having the multi-USIM presence from AMF 406, HSS 408 may initiate a procedure to obtain multi-USIM radio capability information, which may include information regarding USIM-2's capabilities and UE 402's radio capabilities for multi-USIM based operations.

In action 430, HSS 408 may send a multi-USIM Capability Request (REQ) to AMF 406.

In action 432, AMF 406 may also initiate a multi-USIM capability information update procedure for UE 402.

In action 434, AMF 406 may send a multi-USIM capability update request to gNB 404.

In action 436, gNB 404 may initiate a multi-USIM radio capability information update procedure for UE 402.

In action 438, gNB 404 may send a request to USIM1 of UE 402 to request for USIM-2 capabilities and UE 402's radio capabilities for multi-USIM based operations.

In action 440, a USIM processor (e.g., multi-USIM processor 122 in FIG. 1) of UE 402 may perform multi-USIM information update procedures based on the multi-USIM capability update request.

In action 442, USIM1 may send a multi-USIM UE Radio Capability Update Response (RES) to gNB 404. The multi-USIM UE Radio Capability Update Response may include USIM-2 capabilities and UE 402's radio capabilities for multi-USIM based operations. For example, the multi-USIM UE Radio Capability Update Response may include UE's capabilities to support USIM 2, multi-USIM UE Transmit/Receive Radio Capabilities, simultaneous radio capabilities associated with multi-USIM based operations, radio bands associated with the multi-USIM based operations, information indicating whether the second USIM belongs to the same PLMN as the first USIM and indicating one or more operators associated with the multi-USIM based operations, one or more radio access technologies (RATs) associated with the multi-USIM based operations, and a network preference/priority list associated with the multi-USIM based operations.

The multi-USIM UE Transmit/Receive Radio Capabilities, simultaneous radio capabilities associated with the multi-USIM based operations may include, for example, at least one of the following: a single transmit and single receive configuration, a single transmit and double receive configuration, a double transmit and single receive configuration, and a double transmit and double receive configuration. The transmit and receive configuration above may be realized by, for example, at least one transmitter and at least one receiver. For example, a single transmit and double receive configuration may be realized by one transmitter and two receivers. The one or more RATs associated with the multi-USIM based operations may, for example, include at least one of the following: Code-Division Multiple Access (CDMA) 2000, GSM EDGE Radio Access Network (GERAN), Universal Terrestrial Radio Access (UTRA), Evolved-Universal Terrestrial Radio Access (E-UTRA), and New Radio (NR).

In action 444, gNB 404 may send the Response, including USIM-2 capabilities and UE 402's radio capabilities for multi-USIM based operations, to AMF 406.

In action 446, AMF 406 may update the multi-USIM capability information of UE 402.

In action 448, AMF 406 may send the USIM-2 capabilities and UE 402's radio capabilities for multi-USIM based operations to HSS 408.

In the present implementation, actions 450, 452 and 454 may be substantially similar to actions 348, 350, and 352 in FIG. 3. Thus, the descriptions of actions 450, 452 and 454 are omitted for brevity.

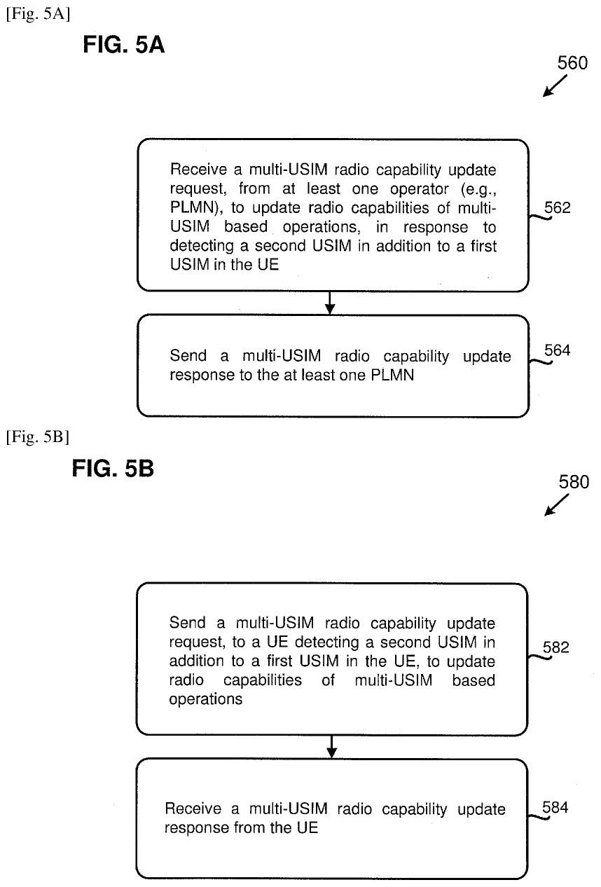

FIG. 5A is a flowchart diagram illustrating a method of a multi-USIM based operation UE for updating the UE's radio capabilities of multi-USIM based operations, in accordance with example implementations of the present disclosure.

As illustrated in FIG. 5A, flowchart 560 may include actions 562 and 564. In the present implementation, the UE may correspond to UE 402 supporting multi-USIM based operations in FIG. 4.

In action 562, a multi-USIM based operation UE may be configured to receive a multi-USIM Radio capability update request, from at least one network/operator (e.g., a Public Land Mobile Network (PLMN)), to update radio capabilities of multi-USIM based operations, in response to detecting the activation of a second USIM in addition to a first USIM in the UE. For example, with reference to FIGS. 4 and 5A, after UE 402 including USIM1 detects the insertion of USIM2, UE 402 may be configured to receive a multi-USIM Radio capability update request (REQ), in action 438 of FIG. 4, from at least one network/operator (e.g., a PLMN), to update UE 402's radio capabilities of multi-USIM based operations. The operator, for example, may include gNB 404, AMF 406, and HSS 408, but is not limited to the equipment describe herein.

In action 564, the UE may be configured to send a multi-USIM UE Radio capability update response to the at least one network/operator. For example, with reference to FIGS. 4 and 5A, UE 402 may be configured to send a multi-USIM UE Radio capability update response (RES), in action 442 of FIG. 4, to gNB 404.

FIG. 5B is a flowchart diagram illustrating a method of a network for updating a UE's radio capabilities of multi-USIM based operations, in accordance with example implementations of the present disclosure.

As illustrated in FIG. 5B, flowchart 580 may include actions 582 and 584. In the present implementation, a network/operator (e.g., a PLMN) may include, but is not limited to, gNB 404, AMF 406, and HSS 408 in FIG. 4.

In action 582, a network/operator may be configured to send a multi-USIM Radio capability update request, to a multi-USIM based operation UE upon receiving information regarding a multi-USIM presence (e.g., USIM1 and USIM2) in the UE, to update the UE's radio capabilities of multi-USIM based operations. For example, with reference to FIGS. 4 and 5B, gNB 404 may be configured to send a multi-USIM Radio capability update request (REQ), in action 438 of FIG. 4, to a multi-USIM based operation UE 402 upon detecting USIM2 in addition to USIM1 in the UE, to update UE 402's radio capabilities of multi-USIM based operations.

In action 584, the network/operator may be configured to receive a multi-USIM UE Radio capability update response from the UE. For example, with reference to FIGS. 4 and 5B, gNB 404 may be configured to receive a multi-USIM UE Radio capability update response (RES), in action 442 of FIG. 4, from UE 402.

The method illustrated in FIG. 4 (along with FIGS. 5A and 5B) allows the network to handle mobile-terminated data or control-plane activity occurrence on a suspended connection requested by the UE. Thus, paging collisions occurring in the UE among active multiple USIM based operations can be avoided. The methods allow a multi-USIM multi-network/operator supported UE to handle emergency calls and sessions. As such, the network and the UE can maintain RRC and CN state while moving from one system to another substantially without any interruption to either sessions/services. In addition, the method illustrated in diagram 400 allows the handling of service prioritization and specifying the UE behavior upon reception of paging information based on USIM configuration and/or user preferences.

In addition, the methods allow the UE to report its multiple U-SIM capabilities, presence of two or more USIMs, and capabilities of simultaneous connections to the networks and indicates its network preference/priority list. As such, the Network and UE may be able to maintain RRC and CN state while moving from one system to the other. This allows the network to activate any special features/services/messaging associated with such multi-USIM capable UEs.

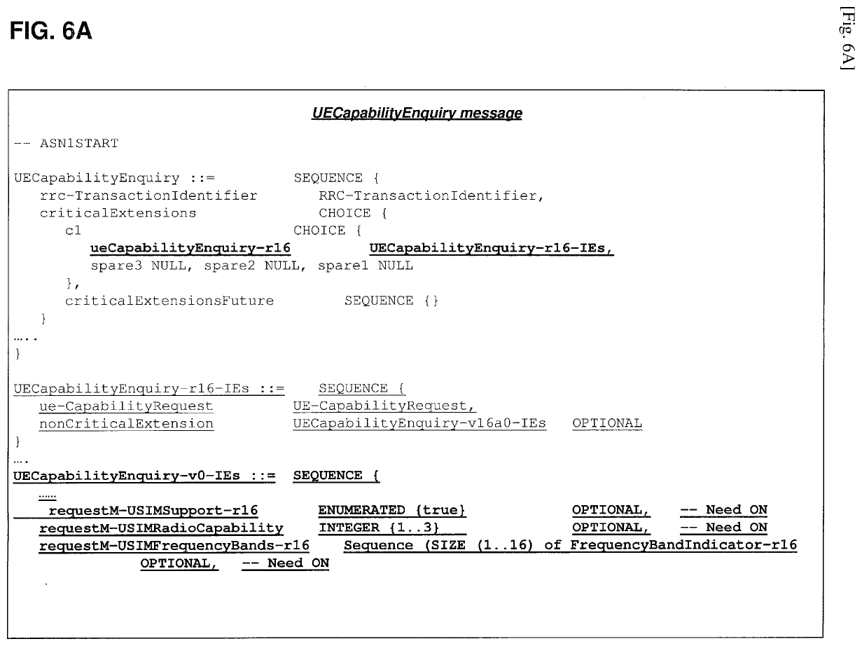

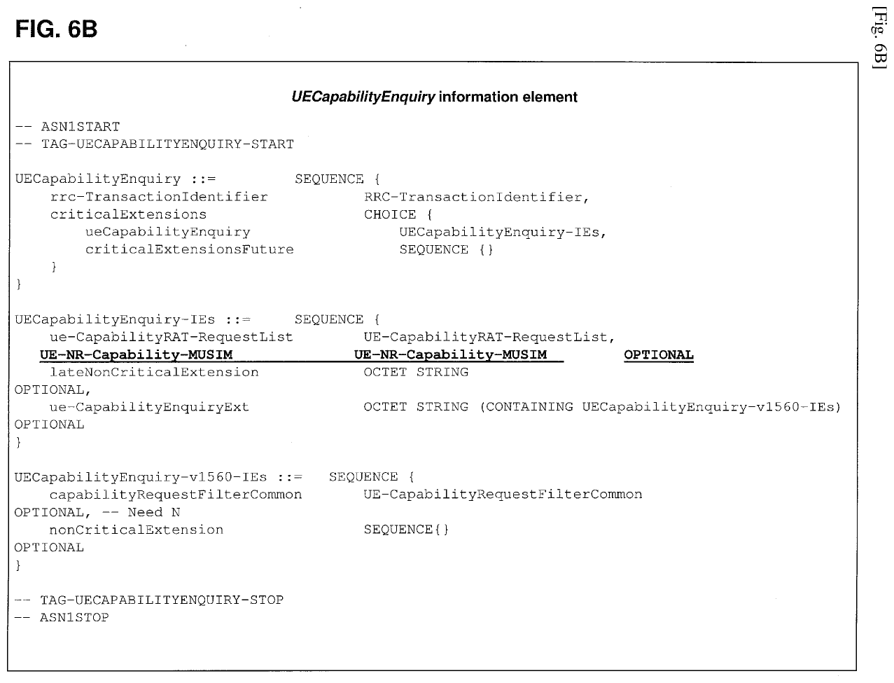

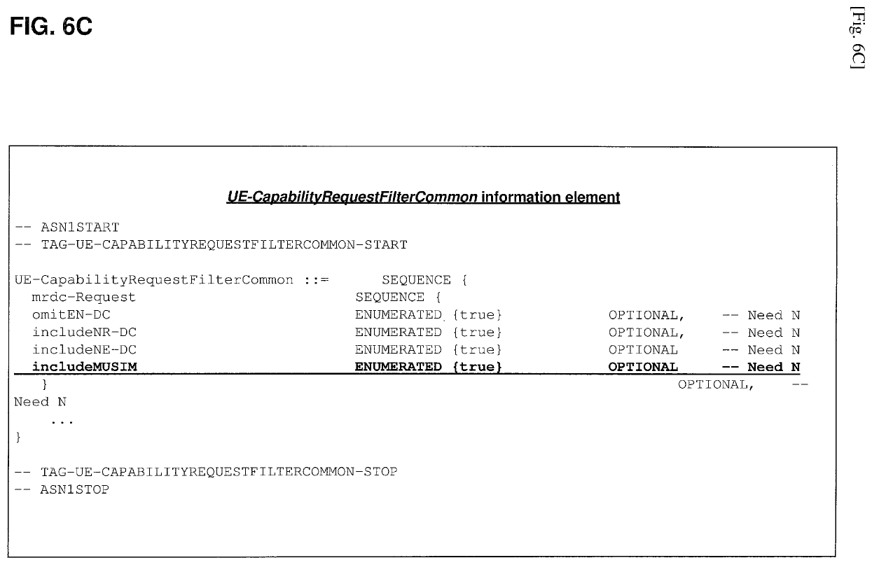

FIGS. 6A, 6B, 6C are diagrams illustrating information elements and information messages through which a multi-USIM Radio capability update request may be transferred, in accordance with example implementations of the present disclosure.

In FIG. 6A, a UECapabilityEnquiry message, for example, may be used to request the transfer of UE radio access capabilities for E-UTRAN when the UE supports LTE protocols. For example, with reference to FIGS. 4 and 6A, gNB 404 may send the multi-USIM Radio capability update request (REQ), in action 438 of FIG. 4, to LTE supporting UE 402 through the UECapabilityEnquiry message, to request the transfer of UE radio access capabilities.

In FIG. 6B, a UECapabilityEnquiry information element, for example, may be used to request UE radio access capabilities for NR when the UE supports NR protocols. For example, with reference to FIGS. 4 and 6B, gNB 404 may send the REQ, in action 438 of FIG. 4, to NR supporting UE 402 through the UECapabilityEnquiry information element, to request UE radio access capabilities for NR.

In FIG. 6C, a UE-CapabilityRequestFilterCommon information element, for example, may be used to request filtered UE capabilities for NR when the UE supports NR protocols. The filter is common for all capabilities containers that are requested. For example, with reference to FIGS. 4 and 6C, gNB 404 may send the REQ, in action 438 of FIG. 4, to NR supporting UE 402 through the UE-CapabilityRequestFilterCommon information element, to request filtered UE capabilities for NR.

In various implementations of the present disclosure, the information elements or messages are not to be limited to the examples provided herein.

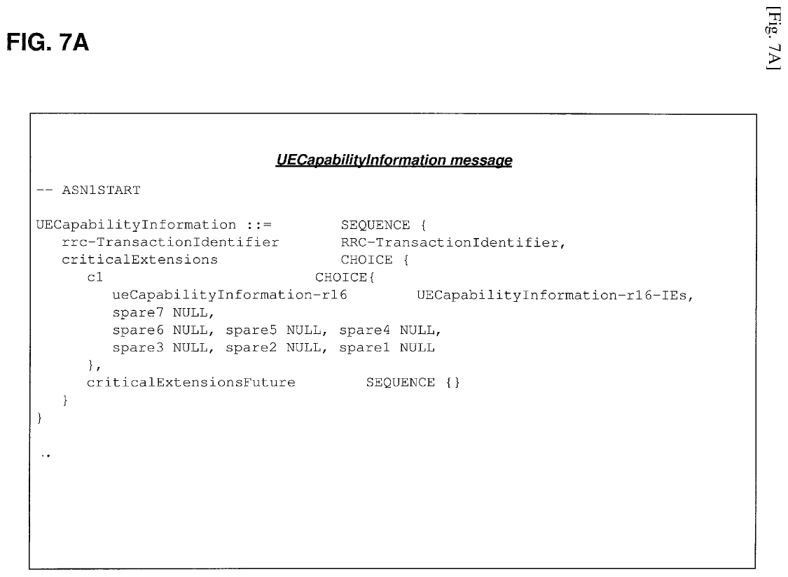

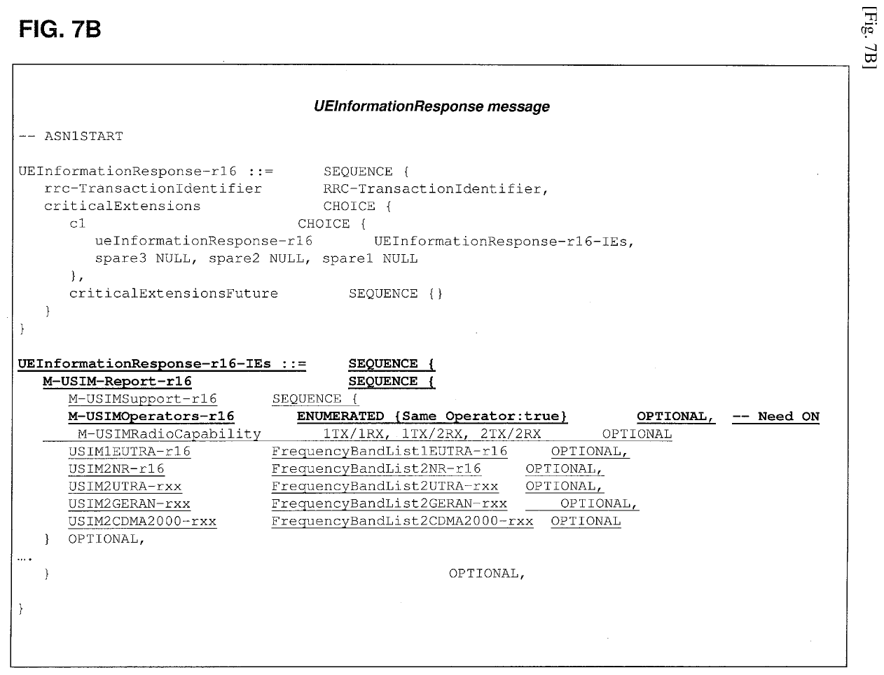

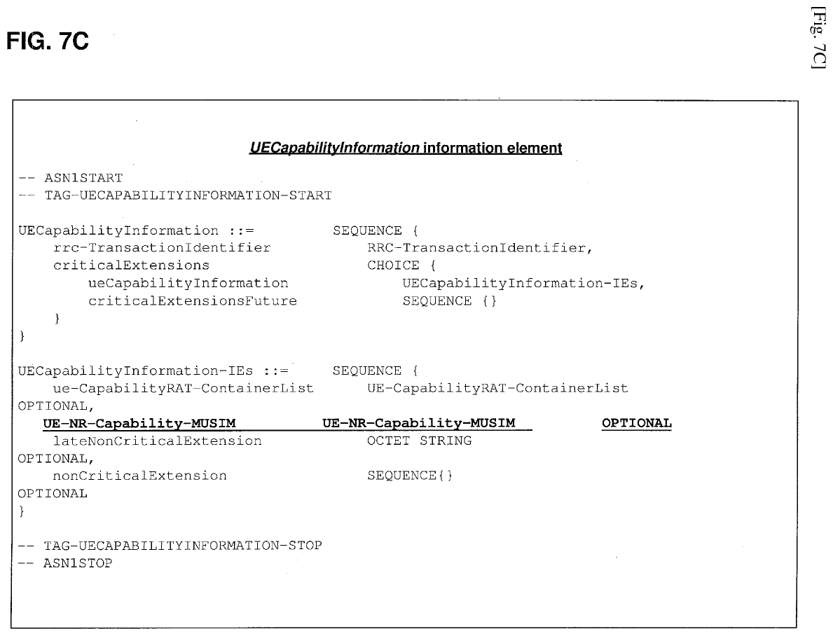

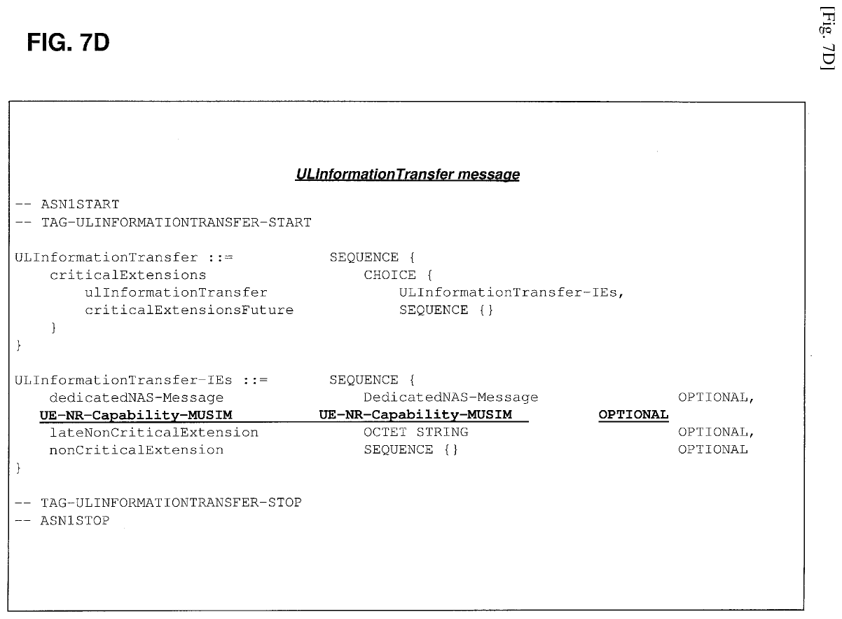

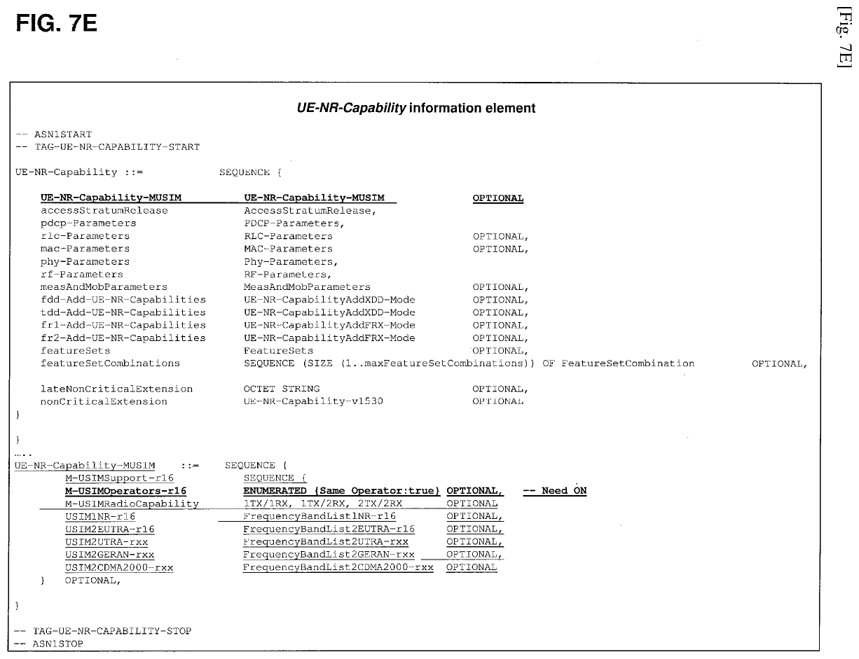

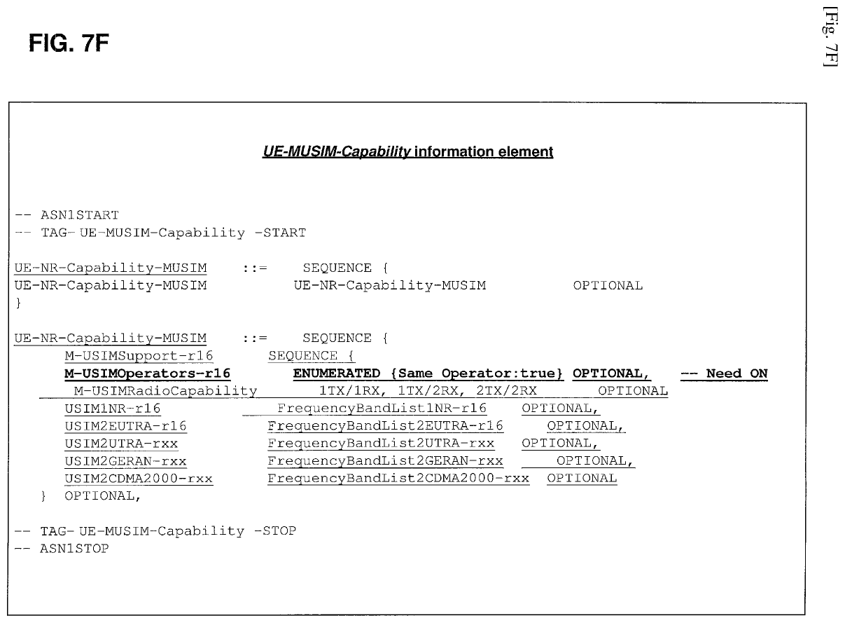

FIGS. 7A, 7B, 7C, 7D, 7E and 7F are diagrams illustrating information elements and information messages through which a multi-USIM UE radio capability update response may be transferred, in accordance with example implementations of the present disclosure.

In FIG. 7A, a UECapabilityInformation message, for example, may be used to transfer UE radio access capabilities requested by E-UTRAN when the UE supports LTE protocols. For example, with reference to FIGS. 4 and 7A, LTE supporting UE 402 may send the multi-USIM UE Radio capability update response (RES), in action 442 of FIG. 4, to gNB 404 through the UECapabilityInformation message, to transfer the UE radio access capabilities.

In FIG. 7B, a UEInformationResponse message, for example, may be used by the UE to transfer the information requested by an E-UTRAN when the UE supports LTE protocols. For example, with reference to FIGS. 4 and 7B, LTE supporting UE 402 may send the RES, in action 442 of FIG. 4, to gNB 404 through the UEInformationResponse message, to transfer the information requested by an E-UTRAN.

In FIG. 7C, a UECapabilityInformation information element, for example, may be used to transfer UE radio access capabilities requested by an NR network when the UE supports NR protocols. For example, with reference to FIGS. 4 and 7C, NR supporting UE 402 may send the RES, in action 442 of FIG. 4, to gNB 404 through the UECapabilityInformation information element, to transfer UE radio access capabilities requested by an NR network.

In FIG. 7D, a ULinformationTransfer message, for example, may be used for the uplink transfer of NAS or non-3GPP dedication information when the UE supports NR protocols. For example, with reference to FIGS. 4 and 7D, NR supporting UE 402 may transfer the RES, in action 442 of FIG. 4, to gNB 404 through the ULInformationTransfer message, for the uplink transfer of NAS or non-3GPP dedication information.

In FIG. 7E, a UE-NR-Capability information element, for example, may be used to convey the NR UE Radio Access Capability Parameters when the UE supports NR protocols. For example, with reference to FIGS. 4 and 7E, NR supporting UE 402 may send the RES, in action 442 of FIG. 4, to gNB 404 through the UE-NR-Capability information element, to convey the NR UE Radio Access Capability Parameters.

In FIG. 7F, a UE-MUSIM-Capability information element, for example, may be used, together with the message type, for the identification of Multiple USIM support (presence/activated) within the UE when the UE supports NR protocols. For example, with reference to FIGS. 4 and 7F, NR supporting UE 402 may send the RES, in action 442 of FIG. 4, to gNB 404 through the UE-MUSIM-Capability information element, for the identification of Multiple USIM support within the UE.

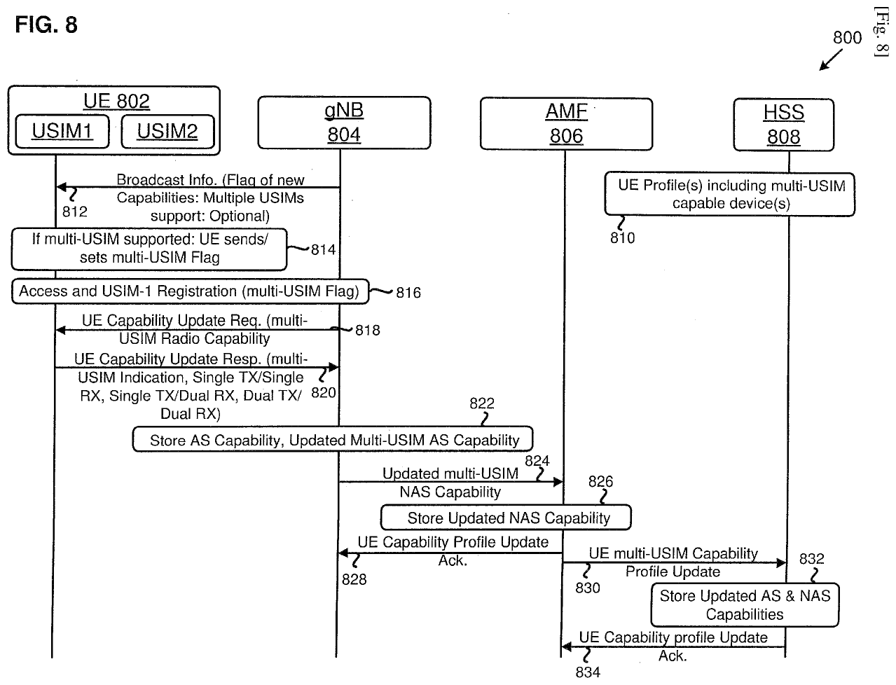

FIG. 8 is a signaling sequence diagram for schematically illustrating a method of broadcasting a broadcast message indicating multi-USIM support by a base station and updating a UE's radio capabilities of multi-USIM based operations, in accordance with example implementations of the present disclosure.

In the present implementation, diagram 800 may include actions 810, 812, 814, 816, 818, 820, 822, 824, 826, 828, 830, 832, and 834. In one implementation, UE 802 described in diagram 800 may correspond to multi-USIM UE 102 in FIG. 1 and/or multi-USIM UEs 302 and 402 in FIGS. 3 and 4.

In action 810, HSS 808 may store one or more UE profiles, which may include one or more multi-USIM capable devices.

In action 812, gNB 804 may broadcast information regarding whether gNB 804 supports multi-USIM based operations. For example, gNB 804 may broadcast through a Master Information Block (MIB) or a System Information Block (SIB), a message having a flag indicating whether gNB 804 supports multi-USIM based operations. Also, gNB 804 may broadcast the capabilities of gNB 804 associated with multi-USIM based operations.

UE 802 may receive a broadcast message from gNB 804, for example, through USIM1.

In action 814, UE 802 may send or set an indication (e.g., a flag) indicating that UE 802 supports multi-USIM based operations.

In action 816, UE 802 may perform an access and registration procedure for USIM1 based on the broadcast message, and report a presence and support of multi-USIM based operations to gNB 804 when the broadcast message in action 812 indicates that gNB 804 supports the multi-USIM based operations, or the multi-USIM based operations are active. During the access and registration procedure for USIM1, UE 802 may also include an indication (or a flag) indicating to gNB 804 that UE 802 supports multi-USIM based operations.

In action 816, when the broadcast message indicates that gNB 804 does not support the multi-USIM based operations, or the multi-USIM based operations are not active, UE 802 may only perform a registration procedure for USIM1 without indicating UE 802's multi-USIM capabilities.

In action 818, upon receiving UE 802's indication of multi-USIM based operation support, gNB 804 may send UE 802 a multi-USIM radio capability update request (REQ) to update radio capabilities of multi-USIM based operations. UE 802 may receive the REQ, from gNB 804, to update UE 802's radio capabilities of multi-USIM based operations.

In action 820, the UE may be configured to send a multi-USIM UE Radio capability update response (RES) to the base station. For example, UE 802 may send the RES to gNB 804 to update UE 802's radio capabilities of multi-USIM based operations.

In action 822, gNB 804 may store UE 802's AS capabilities and update multi-USIM AS capabilities of UE 802.

In action 824, gNB 804 may send a message to AMF 806 to update the multi-USIM NAS capabilities.

In action 826, AMF 806 may store the updated NAS capabilities with multi-USIM based operation capabilities of UE 802.

In action 828, AMF 806 may send a UE Capability Profile Update Acknow1-edgement to gNB 804.

In action 830, AMF 806 may send a message to HSS 808 to update UE 802's multi-USIM capability profile.

In action 832, HSS 808 may update and store the updated AS and NAS capabilities of UE 802.

In action 834, HSS 808 may send a UE Capability Profile Update Acknowledgement to AMF 806.

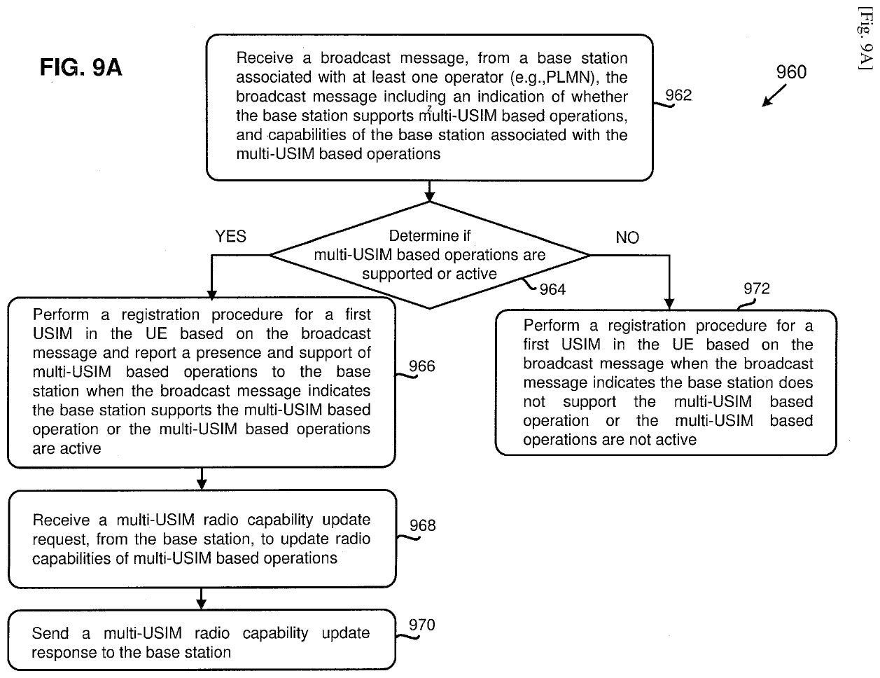

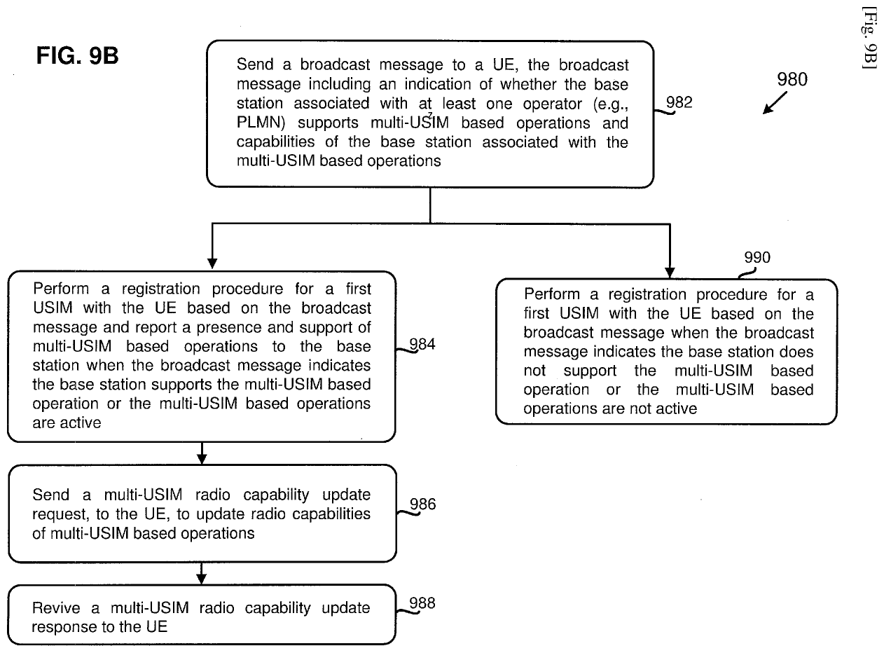

FIG. 9A is a flowchart diagram illustrating a method of a UE for receiving a broadcast message indicating multi-USIM support from a base station, and sending the UE's radio capabilities or radio capability update for multi-USIM based operations to the base station, in accordance with example implementations of the present disclosure.

As illustrated in FIG. 9A, flowchart 960 may include actions 962, 964, 966, 968, 970, and 972. In the present implementation, the UE may correspond to UE 802 supporting multi-USIM based operations in FIG. 8.

In action 962, a multi-USIM based operation UE may receive a broadcast message, from a base station associated with at least one network/operator (e.g., a PLMN). The broadcast message may include an indication of whether the base station supports multi-USIM based operations, and capabilities of the base station associated with the multi-USIM based operations. For example, with reference to FIGS. 8 and 9A, UE 802 may be configured to receive a broadcast message from gNB 804 associated with at least one network/operator (e.g., a PLMN). The broadcast message may include an indication (or a flag) of whether gNB 804 supports multi-USIM based operations and capabilities of gNB 804 associated with the multi-USIM based operations.

In action 964, the UE may determine whether the base station supports the multi-USIM based operations, or the multi-USIM based operations are active, based on the broadcast message. If the base station supports the multi-USIM based operations, or the multi-USIM based operations are active, flowchart 960 may proceed to actions 966, 968, and 970. If the base station does not support the multi-USIM based operations, or the multi-USIM based operations are not active, flowchart 960 may proceed to action 972.

In action 966, the UE perform a registration procedure for a first USIM based on the broadcast message and report a presence and support of multi-USIM based operations to the base station when the broadcast message indicates that the base station supports the multi-USIM based operations, or the multi-USIM based operations are active. For example, with reference to FIGS. 8 and 9A, when the broadcast message indicates that gNB 804 supports the multi-USIM based operations, or the multi-USIM based operations are active, UE 802 may perform a registration procedure for USIM1 and report a multi-USIM presence in UE 802 and UE 802's capabilities and support of multi-USIM based operations to gNB 804.

In action 968, the UE may receive a multi-USIM Radio capability update request (REQ), from the base station, to update radio capabilities of multi-USIM based operations. For example, with reference to FIGS. 8 and 9A, UE 802 may receive the REQ from gNB 804 to update radio capabilities of multi-USIM based operations.

In action 970, the UE may be configured to send a multi-USIM UE Radio capability update response (RES) to the base station. For example, UE 802 may send the RES to gNB 804 to update radio capabilities of multi-USIM based operations.

In action 972, the UE may perform a registration procedure for a first USIM based on the broadcast message when the broadcast message indicates that the base station does not support the multi-USIM based operations, or the multi-USIM based operations are not active. For example, with reference to FIGS. 8 and 9A, when the broadcast message indicates that gNB 804 does not support the multi-USIM based operations, or the multi-USIM based operations are not active, UE 802 may only perform a registration procedure for USIM1 without indicating the multi-USIM presence in UE 802 or UE 802's capabilities and support of multi-USIM based operations to gNB 804.

FIG. 9B is a flowchart diagram illustrating a method of a base station for broadcasting a broadcast message indicating multi-USIM support by the base station and receiving radio information or radio capability update information from a UE for multi-USIM based operations, in accordance with example implementations of the present disclosure. As illustrated in FIG. 9B, flowchart 980 may include actions 982, 984, 986, 988, and 990. In the present implementation, the base station and UE may correspond to gNB 804 and UE 802, respectively, in FIG. 8.

In action 982, a base station may be configured to broadcast a message, which may be received by one or more UEs. The broadcast message may include an indication of whether the base station supports multi-USIM based operations, and capabilities of the base station associated with the multi-USIM based operations. For example, with reference to FIGS. 8 and 9B, gNB 804 associated with at least network/operator (e.g., a PLMN) may broadcast a message. The broadcast message may include an indication (or a flag) of whether gNB 804 supports multi-USIM based operations and capabilities of gNB 804 associated with the multi-USIM based operations.

In action 984, if the base station supports the multi-USIM based operations, or the multi-USIM based operations are active, flowchart 980 may proceed to actions 984, 986, and 988. If the base station does not support the multi-USIM based operations, or the multi-USIM based operations are not active, flowchart 980 may proceed to action 990.

In action 984, the base station may be configured to perform a registration procedure for a first USIM based on the broadcast message and receive a presence and support of multi-USIM based operations from the UE when the broadcast message indicates that the base station supports the multi-USIM based operations, or the multi-USIM based operations are active. For example, with reference to FIGS. 8 and 9B, when the broadcast message indicates that gNB 804 supports the multi-USIM based operations, or the multi-USIM based operations are active, gNB 804 may perform a registration procedure for USIM1 and receive a multi-USIM presence in UE 802 and UE 802's capabilities and support of multi-USIM based operations from UE 802.

In action 986, the base station may send a multi-USIM Radio capability update request (REQ), to the UE, to update radio capabilities of multi-USIM based operations. For example, with reference to FIGS. 8 and 9B, gNB 804 may send the REQ, to UE 802, to update radio capabilities of multi-USIM based operations.

In action 988, the base station may receive a multi-USIM UE Radio capability update response (RES) from the UE. For example, gNB 804 may receive the RES from UE 802.

In action 990, the base station may be configured to perform a registration procedure for a first USIM based on the broadcast message when the broadcast message indicates that the base station does not support the multi-USIM based operations, or the multi-USIM based operations are not active. For example, with reference to FIGS. 8 and 9B, when the broadcast message indicates that gNB 804 does not support the multi-USIM based operations, or the multi-USIM based operations are not active, gNB 804 may only perform a registration procedure for USIM without information from UE 802 indicating the multi-USIM presence in UE 802 or UE 802's capabilities and support of multi-USIM based operations.

The method illustrated in FIG. 8 (along with FIGS. 9A and 9B) allows the network to indicate its capabilities and support for multi-USIM based operations. As the network providing UEs under its coverage with the indication on whether the network is capable of multi-USIM based operations, the signaling overhead, that would have otherwise incurred due as a result of UEs attempting to update their multi-USIM capabilities with the network, can be effectively avoided. In addition, the method illustrated in diagram 800 allows the handling of service prioritization based on the base station's capabilities and/or user preferences.

1. A user equipment (UE) for wireless communication, the UE comprising:
one or more non-transitory computer-readable media having computer-executable instructions embodied thereon;
at least one processor coupled to the one or more non-transitory computer-readable media, and configured to execute the computer-executable instructions to:
receive a multiple-universal subscriber identity module (multi-USIM) Radio capability update request, from at least one Public Land Mobile Network (PLMN), to update radio capabilities of multi-USIM based operations, in response to detecting the activation of a second USIM in addition to a first USIM in the UE; and
send a multi-USIM UE Radio capability update response to the at least one PLMN.

2. (canceled)

3. A method of a user equipment (UE), the method comprising:
receiving a multiple-universal subscriber identity module (multi-USIM) Radio capability update request, from at least one Public Land Mobile Network (PLMN), to update radio capabilities of multi-USIM based operations, in response to detecting the activation of a second USIM in addition to a first USIM in the UE; and
sending a multi-USIM UE Radio capability update response to the at least one PLMN.

4. A base station comprising:
one or more non-transitory computer-readable media having computer-executable instructions embodied thereon;
at least one processor coupled to the one or more non-transitory computer-readable media, and configured to execute the computer-executable instructions to:
send a multiple-universal subscriber identity module (multi-USIM) Radio capability update request, to a user equipment (UE) detecting a second USIM in addition to a first USIM in the UE, to update radio capabilities of multi-USIM based operations;
receive a multi-USIM UE Radio capability update response from the UE.

5. (canceled)

6. (canceled)
